(19) United States
(12) Patent Application Publication
(10) Pub. No.: US 2022/0054871 A1
(43) Pub. Date: Feb. 24, 2022

(54) FACE MASK WITH REMOVABLE FILTER

(71) Applicant: BILLINGS CLINC, Billings, MT (US)

(72) Inventors: Marlin Dustin RICHARDSON, Billings, MT (US); Colton LeGard Zaugg, Billings, MT (US); Spencer Elwood Zaugg, Billings, MT (US)

(73) Assignee: BILLINGS CLINC, Billings, MT (US)

(21) Appl. No.: 17/224,905

(22) Filed: Apr. 7, 2021

Related U.S. Application Data
(60) Provisional application No. 63/006,581, filed on Apr. 7, 2020.

(51) Int. Cl. A62B 23/02

(52) U.S. Cl. CPC A62B 23/025

(57) ABSTRACT

A filtering face mask includes a mask body, a filter frame, and a filter. The mask body is configured to cover a user's nose and mouth to define an interior cavity. The mask body defines an opening for the passage of air between the interior cavity and the ambient atmosphere. The filter frame fits within the opening in the mask body. The filter frame has an interior side facing the interior cavity and an exterior side facing away from the user. An outer edge of the filter frame is situated adjacent to an interior side of the opening. The filter frame defines one or more air passages that permit airflow between the interior side and the exterior side. The filter covers the air passages. The filter may be held in place between the edge of the filter frame and the interior side of the opening.

### CROSS-REFERENCE TO RELATED APPLICATIONS

This application claims priority to U.S. Provisional Patent Application No. 63/006,581, filed Apr. 7, 2020, which is incorporated herein by reference in its entirety.

### TECHNICAL FIELD

The present disclosure relates generally to a reusable face mask device having a removeable breathing filter.

### BACKGROUND

Filtering face masks—sometimes referred to as respirators, surgical masks, dust masks, etc.—have been used in various fields for various purposes to protect the wearer from inhaling contaminants that are present in the ambient environment, such as dust, fumes, germs, viruses, bacteria, and other particulate. A common mask design covers the wearer's nose and mouth to separate the ambient air from the mask interior. This is done typically for one of two reasons, either to protect the wearer from potential contaminants in the ambient air or to protect other persons from being exposed to pathogens or other contaminants expelled by the wearer. Such masks are used by many industries, including construction, manufacturing, auto painting and repair, pharmaceutical preparation, surgery, and the like.

Filtering face masks generally fall into one of two categories, namely, flat-fold masks and shaped masks. Flat-fold masks are stored flat but include seams, pleats, and/or folds that allow the mask to be opened into a cup-shaped configuration for use. Examples of flat-fold filtering face-piece respirators are shown in U.S. Pat. Nos. 6,568,392 and 6,484,722 to Bostock et al. and U.S. Pat. No. 6,394,090 to Chen. Shaped masks, in contrast, are more-or-less permanently formed into a desired face-fitting configuration and generally retain that configuration during storage and use. Examples of patents that disclose shaping layers for supporting filtration layers include U.S. Pat. No. 7,131,442 to Kronzer et al., U.S. Pat. No. 4,850,347 to Skov, U.S. Pat. No. 4,807,619 to Dyrud et al., and U.S. Pat. No. 4,536,440 to Berg.

Filtering face masks typically are constructed to have the filter media as an integral part of the mask body. As such the filter media cannot be replaced from the mask body without destroying much of the respirator. To preserve the useful parts of the mask once the filter media has met the end of its service life, masks therefore have been designed, which have replaceable filter cartridges or replaceable filter media attached to or included in the mask body, such as those disclosed in U.S. Pat. No. 6,277,178 to Holmquist-Brown et al., U.S. Pat. No. 3,521,630 to Westberg, and U.S. Patent Application Publication No. US 2003/0005934 A1 filed by Japuntich, et al., U.S. Pat. Nos. 4,628,927 and 4,520,509 to Ward.

Conventional face masks with reusable filter cartridges are not practical for several reasons, which are particularly acute in the medical industry where numerous professionals wear masks for long periods of time every day. Particularly, conventional masks with removeable filtration systems are bulky, they are difficult to sanitize, and require too much time to change filter systems.

### SUMMARY

The present disclosure is directed to a filtering face mask with a removable filter. The face mask includes a mask body that is configured to cover a user's nose and mouth to define an interior cavity. The body includes an interior edge that is adapted to fit to a contour of a user's face. The mask body defines an opening for the passage of air between the interior cavity and the ambient atmosphere. The mask also includes a filter frame that fits within the opening in the mask body. The frame has an interior side facing the interior cavity and an exterior side facing away from the user. An outer edge of the filter frame is situated adjacent to an interior side of the opening. The filter frame defines one or more air passages that permit airflow between the interior side and the exterior side. The mask also includes a filter that covers the air passages. The filter may be held in place between the edge of the filter frame and the interior side of the opening. Alternatively, the filter may be carried by and self-contained in the filter frame such that mounting the filter frame to the mask body concurrently mounts the filter frame to the mask body.

The filter material may be removably attached to the filter frame. The filter material may be situated between the outer edge of the filter frame and the interior surface of the mask body. The filter material may be held in place by pressure between the outer edge of the filter frame and the interior edge of the mask body. The filter frame may further include one or more tension knobs, and the filter material may be held in place between the one of more tension knobs of the filter frame and the interior surface of the mask body. The filter frame may include a flange running generally along at least a portion of the outer edge, the flange to control movement of the filter frame within the opening. The filter frame may include a flange running generally along at least a portion of the outer edge proximate the outer side, the flange to prevent the filter frame from falling into the interior cavity. The mask body may further include a flange situated along at least a portion of the interior side of the opening, the flange to prevent the filter frame from falling into the interior cavity. The filtering mask device may further include a gasket running along the interior edge and adapted to form a substantially airtight seal between the mask body and the user's face.

The filter frame may include a taper angle to match an angle in the mask or to mate against a surface with no angle to allow for a tight seal between the filter frame, the mask, and the filter. The mask body may be generally rigid. In another embodiment, the mask body may be formed from a plastic material or a pliable softer material that conforms to features of the face and/or skin. Mask composition may allow for an inverted seal to the face. The composition of the mask composition and the composition of the filter may be of different to provide, for example, different rigidity to allow for a press-fit, interference-fit, or snap-fit seal between the frame and the mask.

Another aspect of the present disclosure relates to a method of assembling a filtering mask device. The method includes providing a mask body, a filter frame, and a filter material, the mask body configured to cover a user's nose and mouth to define an interior cavity of air therearound, the mask body comprising an interior edge adapted to fit to a contour of the user's face, and an opening having an interior surface, a filter frame having an interior side, an exterior side, and an outer edge, the filter frame defining one or more air passages that permit airflow between the interior side and the exterior side. The method further includes positioning the filter frame substantially within the opening of the mask body, and arranging the filter material covering the one or more air passages to filter air passing therethrough.

The method may include releasably connecting the filter material to the filter frame. The method may include releasably connecting the filter frame to the mask body. The filter material may be fixed to the filter frame, and the filter frame may be removably mounted to the mask body. The filter material may be fixed to the filter frame, and the filter frame may be replaceable with a separate filter frame with separate filter material. The method may further include providing a snap-fit connection between the filter frame and the mask body.

Filter adapters may also be used in the opening of the mask to allow for attachment of existing filters or filter devices. Filter adapters may be connected using, for example, threaded engagement, partial turn engagement, or press-fit or interference fit engagement. Filter adapters may protrude from the opening of the mask to allow for increased surface area or attachment of other devices to the mask.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a front view of an example filtering face mask device in accordance with this disclosure.

FIG. 2 shows a perspective view of the top of the mask device in accordance with this disclosure.

FIGS. 3A, 3B, and 3C show, respectively, views of the top, side, and front of one embodiment of the mask body in accordance with this disclosure.

FIG. 3D shows a perspective view of the mask body in accordance with this disclosure.

FIGS. 4A, 4B, and 4C show, respectively, a side, top, and perspective view of a filter frame device in accordance with this disclosure.

FIGS. 5A, 5B, 5C, and 5D show, respectively, a top, side, front, and perspective view of an alternative embodiment of filtering mask body in accordance with this disclosure.

FIGS. 6A, 6B, and 6C show, respectively, a side, top, and perspective view of an alternative embodiment of a filter frame in accordance with this disclosure.

FIG. 7 shows a perspective view of the side of the mask body 12 depicted in FIGS. 3A, 3B, 3C, and 3D.

FIG. 8 shows a front view of the mask body depicted in FIGS. 3A, 3B, 3C, and 3D.

FIG. 9 shows a bottom view of the side of the mask body depicted in FIGS. 3A, 3B, 3C, and 3D.

FIG. 10 shows a side view of the side of the mask body depicted in FIGS. 3A, 3B, 3C, and 3D.

FIG. 11 shows a top view of the side of the mask body depicted in FIGS. 3A, 3B, 3C, and 3D.

FIG. 12 shows a top view of the filter frame depicted in FIGS. 4A, 4B, and 4C.

FIG. 13 shows a perspective view of the filter frame 30 depicted in FIGS. 4A, 4B, and 4C.

FIG. 14 shows a front view of the embodiment of the mask body depicted in FIGS. 5A, 5B, 5C and 5D.

FIG. 15 shows a top view of the embodiment of the filter frame depicted in FIGS. 6A, 6B, and 6C.

FIG. 16 shows a side view of the filter frame 130 shown in FIG. 15.

FIG. 17 shows a sketch of the mask in accordance with this disclosure, being worn by a user.

FIG. 18 shows a sketch of an assembly view of the mask device in accordance with this disclosure.

FIG. 19 shows a sketch of an assembly view of the mask device in accordance with this disclosure.

FIG. 20 shows a sketch of an assembly view of the mask device in accordance with this disclosure.

FIGS. 21, 22, and 23 show the mask device in accordance with this disclosure being worn by a user.

FIGS. 24A, 24B, and 24C show back perspective views of an alternative embodiment of a filtering mask body in accordance with this disclosure.

FIG. 25 shows a top view of an alternative embodiment of a filter frame including a pleated filter in accordance with this disclosure.

### DETAILED DESCRIPTION

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

The present disclosure is directed to filtering face mask devices and related methods of use. In particular, the present disclosure is directed to a filtering face mask device that has a removable filter, which allows reuse of the mask by cleaning the mask body and easy replacement of the filter.

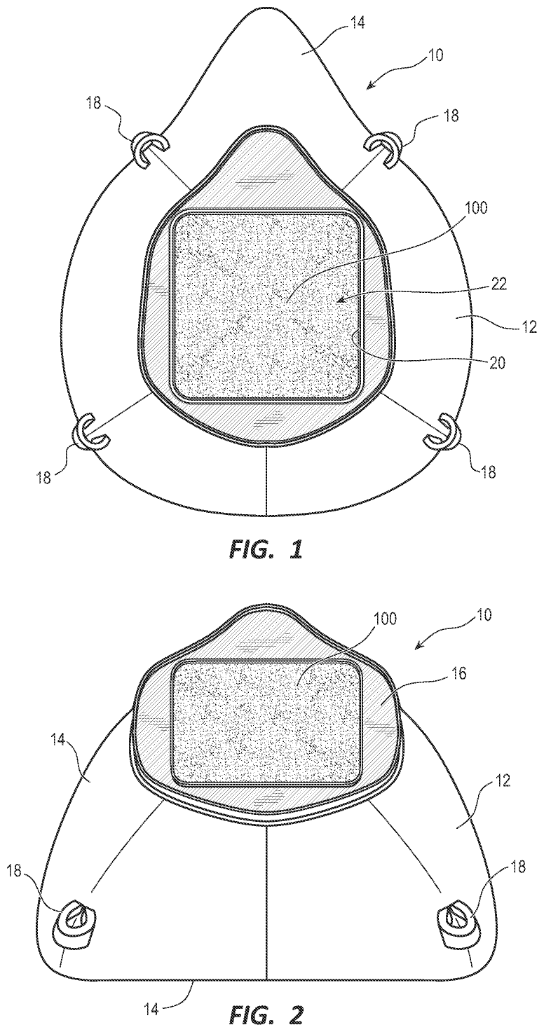

Referring now to FIG. 1, an example filtering face mask device 10 is shown and described. The filtering face mask device 10 includes a mask body 12 and a filter 100 held in place by a filter frame (not shown in FIG. 1). The mask body 12 has an edge 14 that is shaped to fit contours of a user's face. In use, the edge 14 fits against the user's face, and the mask body 12 forms an interior cavity around the user's nose and mouth. In the example of FIG. 1, the mask 10 includes attachment loops 18 for connecting such elastic straps or other fasteners (not shown) that wrap around a user's head, to hold the edge 14 of the mask body 12 against the user's face.

The mask body 12 also includes a front portion 16, which is generally planar in the example of FIG. 1. The mask body 12 defines an opening 22, which is generally square in the example of FIG. 1, but may have different shapes and sizes in other embodiments. In the example of FIG. 1, the filter 100 is a flat, flexible material that is held in place against the outer side of the filter frame (not shown in FIG. 1) and is generally flat and flush with the front portion 16 of the mask body.

FIG. 2 shows a perspective view of the top of the mask 10 depicted in FIG. 1.

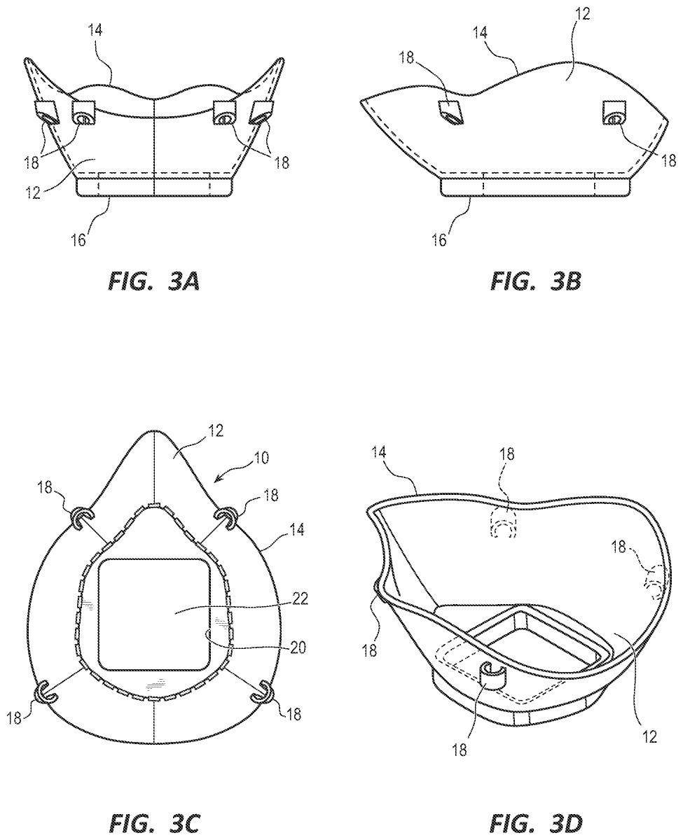

FIGS. 3A, 3B, and 3C show, respectively, views of the top, side, and front of one embodiment of the mask body 12. FIG. 3D shows a perspective view of the mask body 12. The mask body 12 defines an opening 22 in a front portion 16. In this example, the opening 22 is generally square and has an interior side 20. The interior side 20 typically has a depth in the range of about 0.125 inches to about 0.375 inches and is designed to receive the filter frame (not shown) and to hold the filter (not shown) in place between the filter frame and the interior side 20.

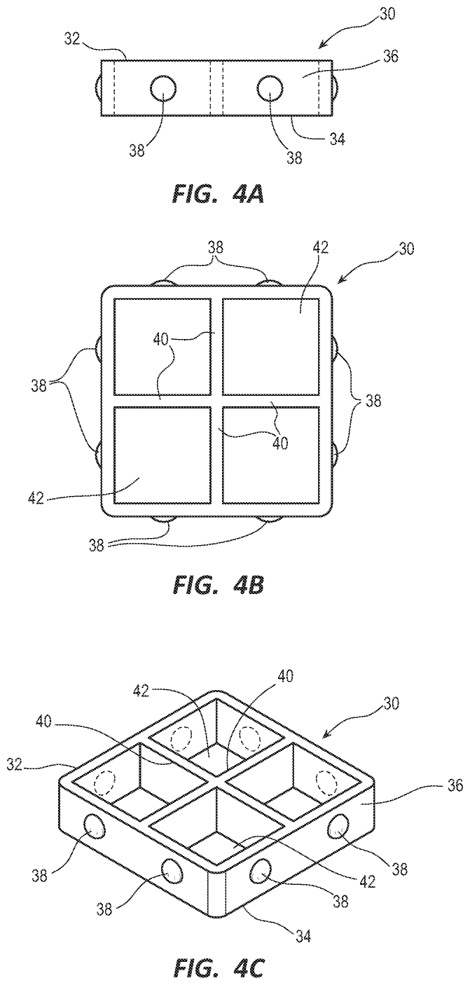

FIGS. 4A, 4B, and 4C show, respectively, a side, top, and perspective view of a filter frame 30. The frame 30 may be formed from a rigid material, such as a plastic, composite, or metal material. In another example, the mask body may be formed from a plastic material or a pliable softer material that forms to the face. Mask composition may allow for an inverted seal to the face. Mask composition and filter composition may be of different rigidity to allow for a press fit seal between the frame and the mask.

In these examples, the frame 30 is generally square and is shaped to fit within in the opening 22 of the mask body 12 (shown in FIG. 3C), but may have other shapes and sizes in other embodiments. The frame 30 is generally flat in this example with an interior side 32 that faces the user and the interior cavity formed by the mask, and is separated by an edge 36 from an exterior side 34 that faces away from the user. The filter frame 30 may include a taper angle to match an angle in the mask or to mate against a surface with no angle to allow for a tight seal between the filter frame 30, the mask body 12 (shown in FIG. 3C), and the filter (not shown, e.g., filter 100).

The frame 30 defines one or more passages 42 that allow flow of air between the interior side 32 and the exterior side 34 of the frame 30. In the example of FIGS. 4A, 4B, and 4C, the frame 30 includes internal supports 40 that connect to sides 36 and form four separate air passages 42. The filter frame 30 may also include one or more tension nubs 38 positioned proximate the edge 36. In use, the tension nubs 38 and the edge 36 of the frame 30 hold the filter (not shown) in place against the interior side 20 of the opening 22 of the mask body 12. The tension nubs 38 may provide a snap-fit or interference-fit connection between the filter frame 30 and the mask body 12, and/or a snap-fit or interference-fit connection that secures the filter to the mask body 12. Alternatively, a fastener, bonding agent, or other connecting feature may be used to secure the filter frame 30 and/or filter to the mask body.

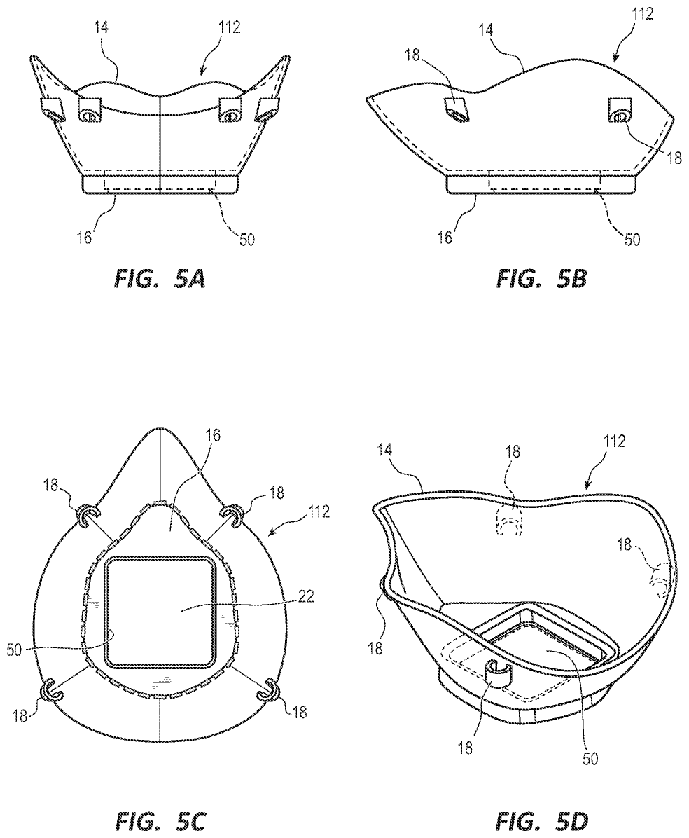

FIGS. 5A, 5B, 5C, and 5D show, respectively, top, side, front, and perspective view of an alternative embodiment of filtering mask body 112 that includes a flange 50 proximate the interior side 20 of the mask body 112. The flange 50 extends into the opening 22 proximate the interior side (e.g., feature 32 shown in FIG. 4A) of the filter frame (e.g., feature 30 shown in FIG. 4A) and restricts movement of the filter frame relative to the interior side 20 of the mask body 112, for example, to prevent the filter frame from falling into the interior cavity.

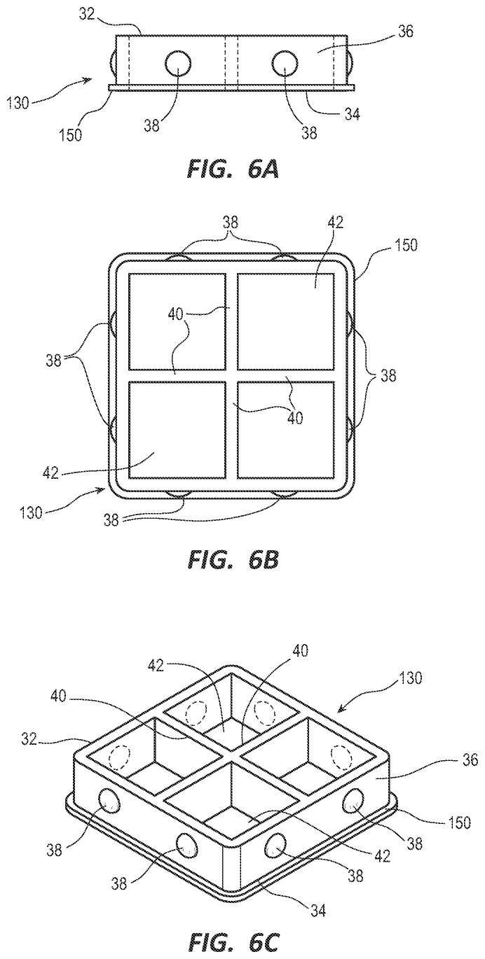

FIGS. 6A, 6B, and 6C show, respectively, side, top, and perspective views of an alternative embodiment of a filter frame 130 that includes a flange 150 on its exterior side 34. The filter frame flange 150 serves a similar purpose as the mask body flange 50 shown in FIGS. 5A, 5B, 5C, in that it limits movement of the filter frame 130 relative to the interior side (e.g., 20 in FIG. 3C) of the mask body (e.g., 12 in FIG. 3C) so that the frame 130 does not fall through the interior opening into the interior cavity of the mask.

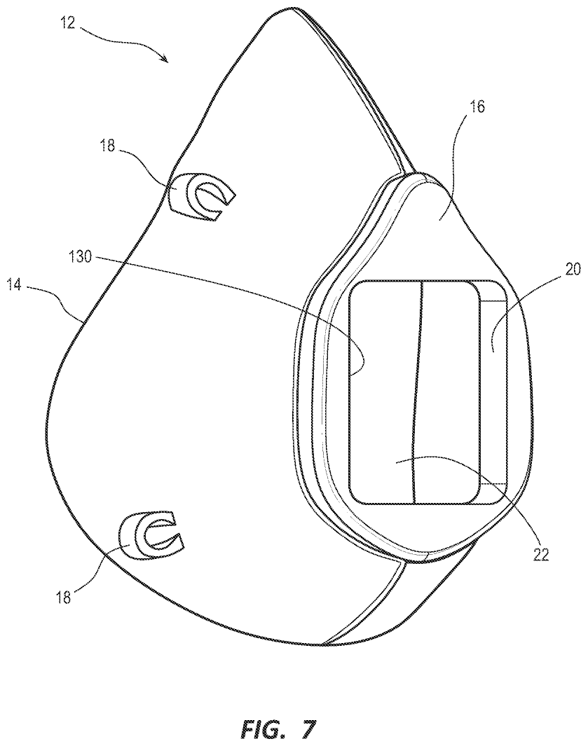

FIG. 7 shows a perspective view of the side of the mask body 12 depicted in FIGS. 3A, 3B, 3C, and 3D.

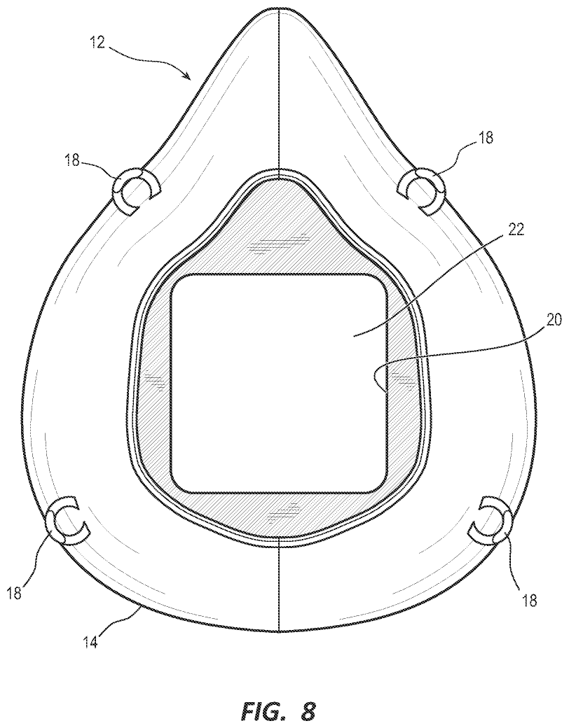

FIG. 8 shows a front view of the mask body 12 depicted in FIGS. 3A, 3B, 3C, and 3D.

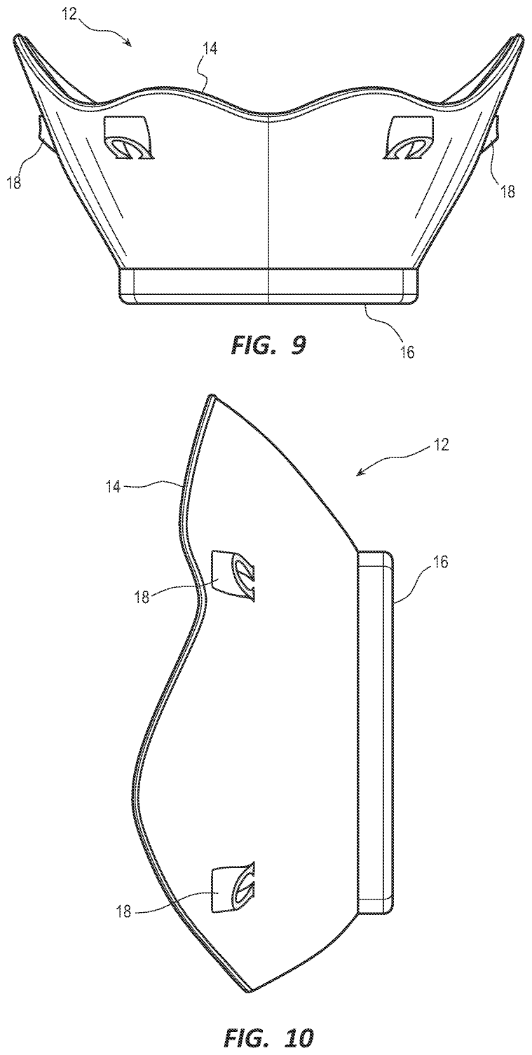

FIG. 9 shows a bottom view of the side of the mask body 12 depicted in FIGS. 3A, 3B, 3C, and 3D.

FIG. 10 shows a side view of the side of the mask body 12 depicted in FIGS. 3A, 3B, 3C, and 3D.

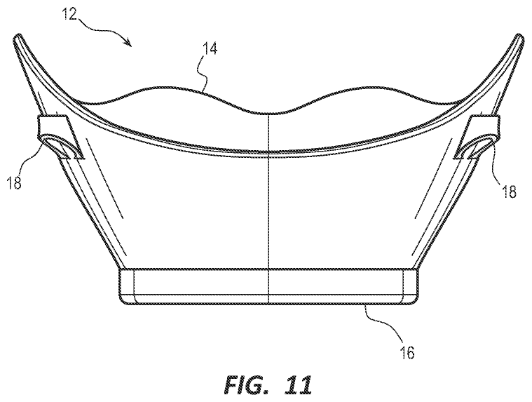

FIG. 11 shows a top view of the side of the mask body 12 depicted in FIGS. 3A, 3B, 3C, and 3D.

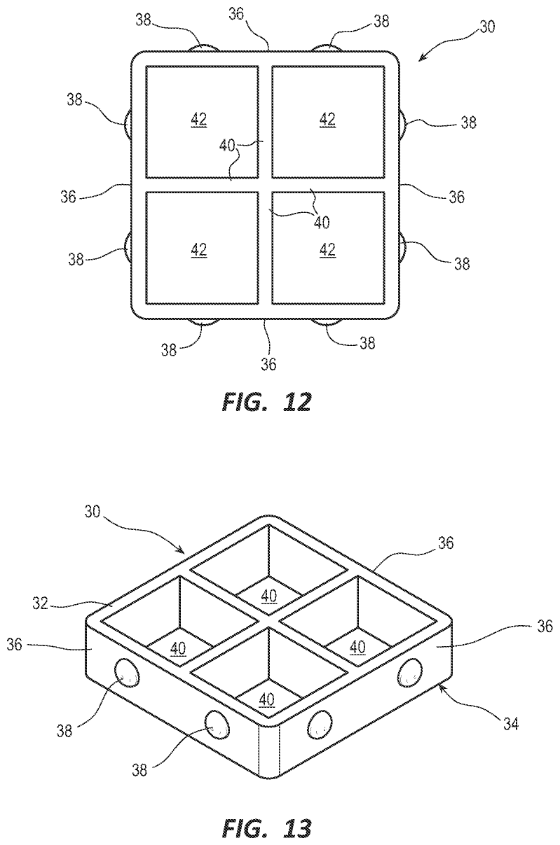

FIG. 12 shows a top view of the filter frame 30 depicted in FIGS. 4A, 4B, and 4C.

FIG. 13 shows a perspective view of the filter frame 30 depicted in FIGS. 4A, 4B, and 4C.

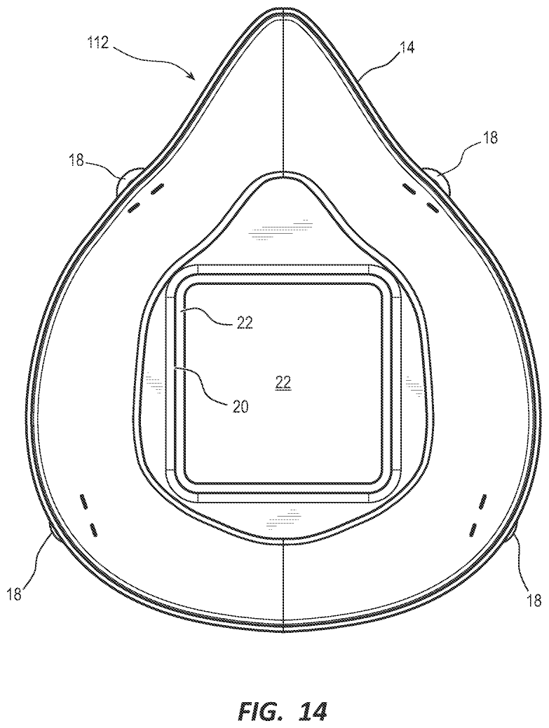

FIG. 14 shows a front view of the embodiment of the mask body 112 depicted in FIGS. 5A, 5B, 5C and 5D. A flange 50 attached to the interior side 20 of the mask body 112 extends into the opening 22 to limit movement of the filter frame (e.g., feature 30 shown in FIGS. 12 and 13) in use.

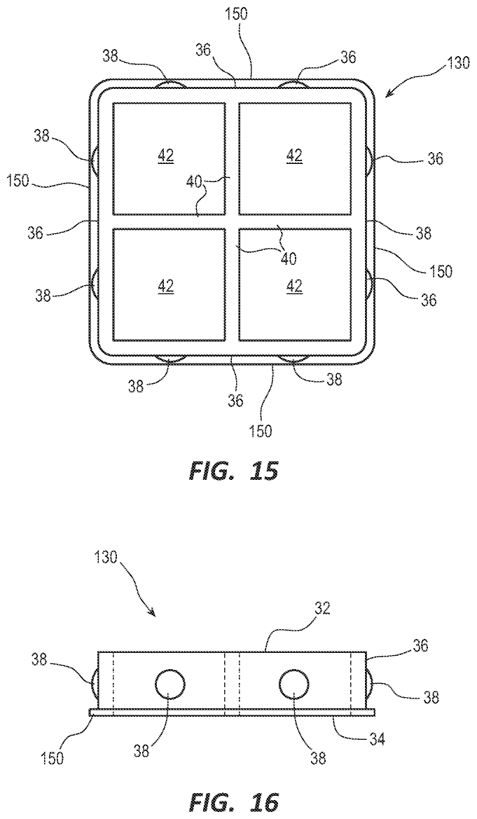

FIG. 15 shows a top view of the embodiment of the filter frame 130 depicted in FIGS. 6A, 6B, and 6C. The filter frame 130 includes a flange 150 adjacent the edge 36 near the exterior side 34. In use, the flange 150 extends outside the side of the opening (e.g., features 20 and 22 shown in FIG. 8) to limit movement of the filter frame 130 relative the mask body (e.g., feature 12 shown in FIG. 8).

FIG. 16 shows a side view of the filter frame 130 shown in FIG. 15. The frame 130 includes a flange 150 proximate the exterior side 34 and extending outward from the edge 36.

Filter adapters may also be used in the opening of the mask to allow for attachment of existing filters or filter devices. Filter adapters may be connected using, for example, threaded engagement, partial turn engagement, or press-fit or interference fit engagement. Filter adapters may protrude from the opening of the mask to allow for increased surface area or attachment of other devices to the mask.

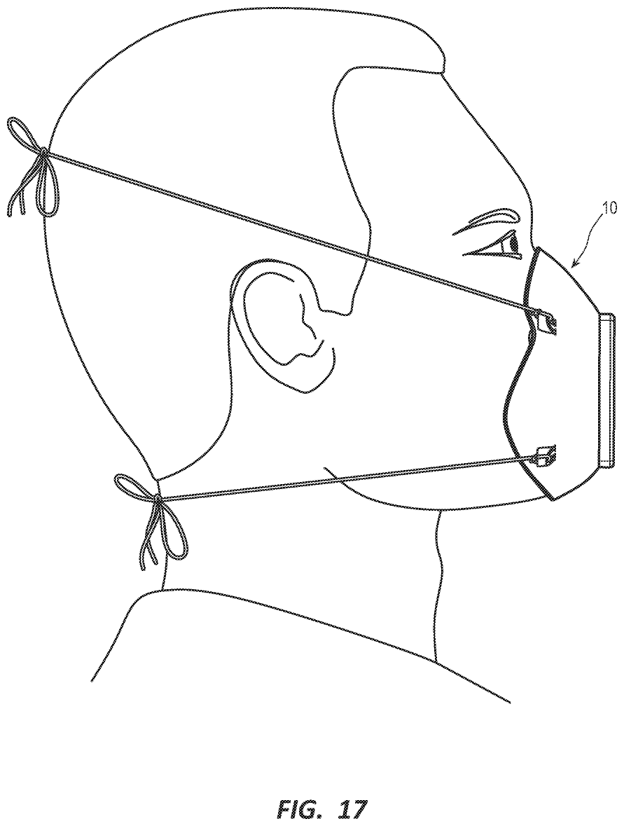

FIG. 17 shows a sketch of the mask 10 being worn by a user.

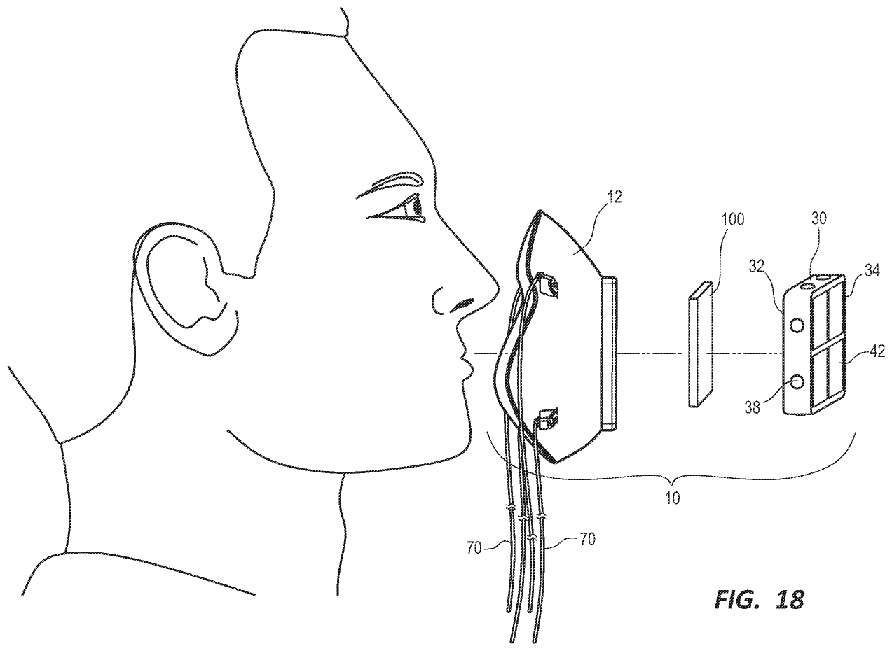

FIG. 18 shows a sketch of an assembly view of the mask 10, including a mask body 12, a filter 100, and a filter frame 30. In this embodiment, the filter 100 is positioned adjacent the interior side 32 of the filter frame 30 and closer to the user. The filter may comprise a flexible material, such as a cloth or fabric, that permits limited airflow through the air passages 42 of the filter frame 30. The filter frame 30 fits snuggly within the opening (e.g., feature 22 shown in FIG. 8) of the mask body 12 to press the filter 100 against the interior side 20 of the opening 22 to hold the filter 100 in place. This embodiment of the filter frame 30 also includes tension nubs 38 to hold the filter 100 in place. In other embodiments (not shown) the filter frame 30 may include a wedge or tapered shape to further assist in creating tension between the frame 30 and the mask body 12 to hold the filter 100 in position.

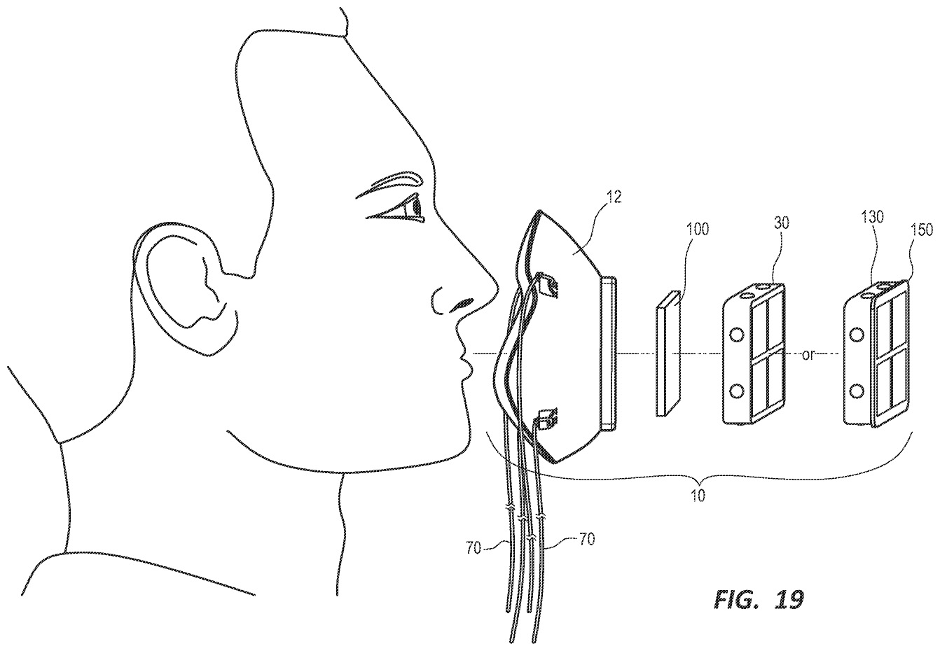

FIG. 19 shows a sketch of an assembly view of the mask 10, including a mask body 12, a filter 100, and alternative embodiments of filter frames 30, 130. One embodiment of the filter frame 130 with a flange 150 extends outward from the opening (e.g., feature 22 shown in FIG. 8) of the mask body 12 to prevent the filter 100 from falling into the interior cavity.

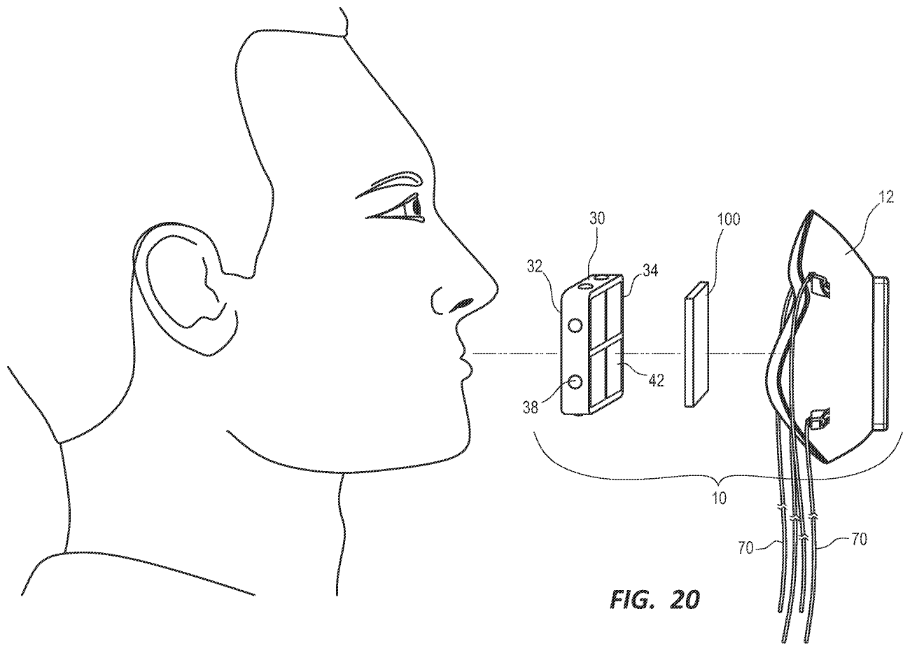

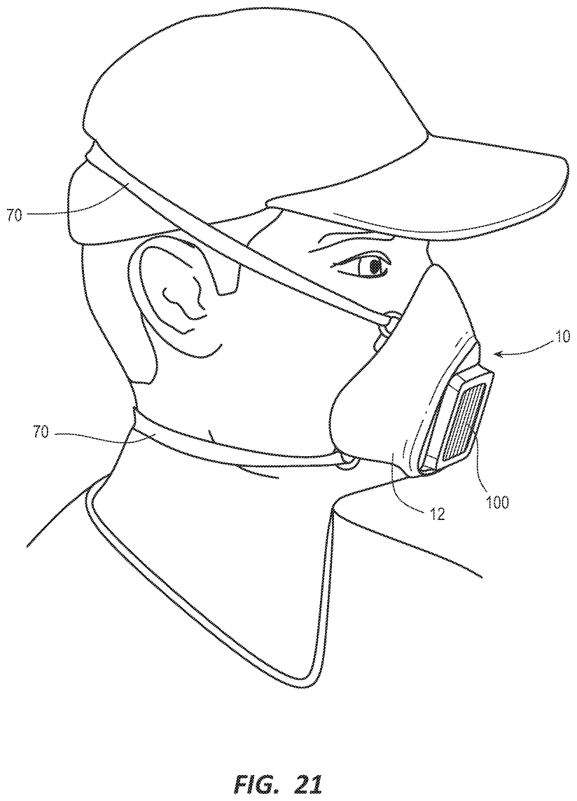

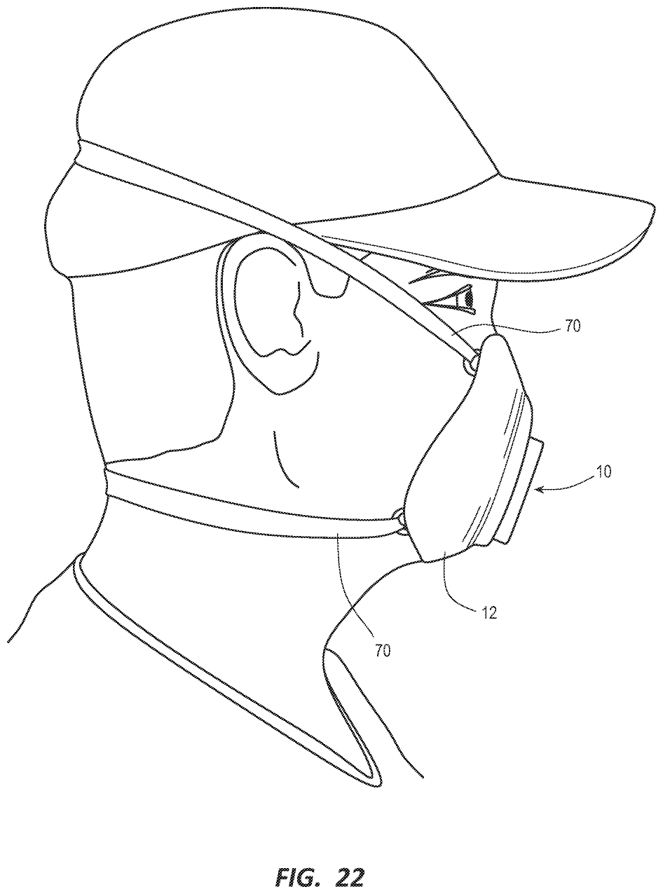

FIG. 20 shows a sketch of an assembly view of the mask 10 in which the filter 100 and filter frame 30 are inserted into a mask body 12 from an interior side of the mask body 12 that is closer to the user. The mask 10 also includes elastic straps 70 or other fasteners to hold the mask 10 in place on a user's head.

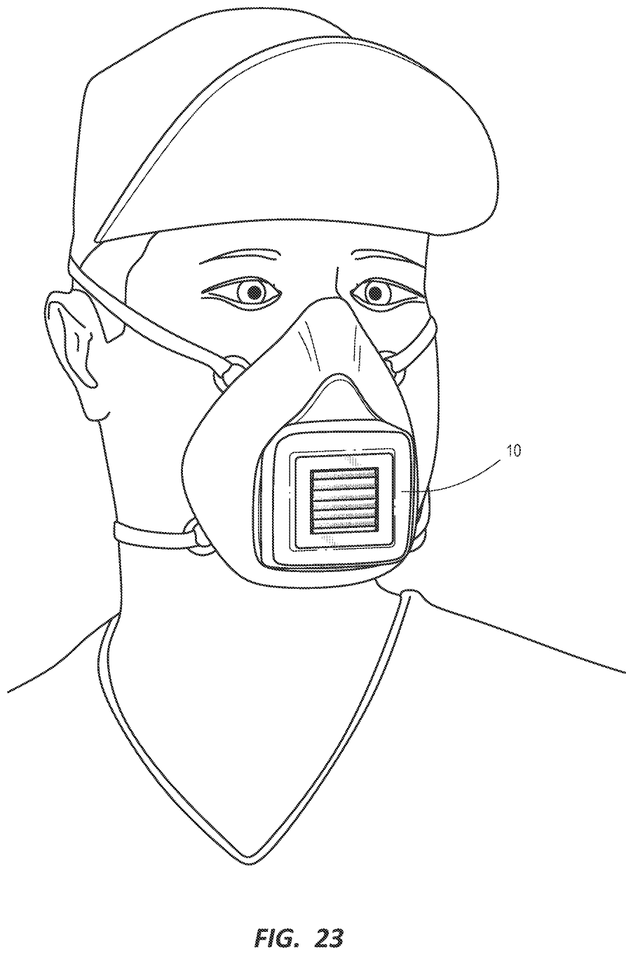

FIGS. 21, 22, and 23 show the mask 10 held in place by a user with straps 70 that wrap around the user's head.

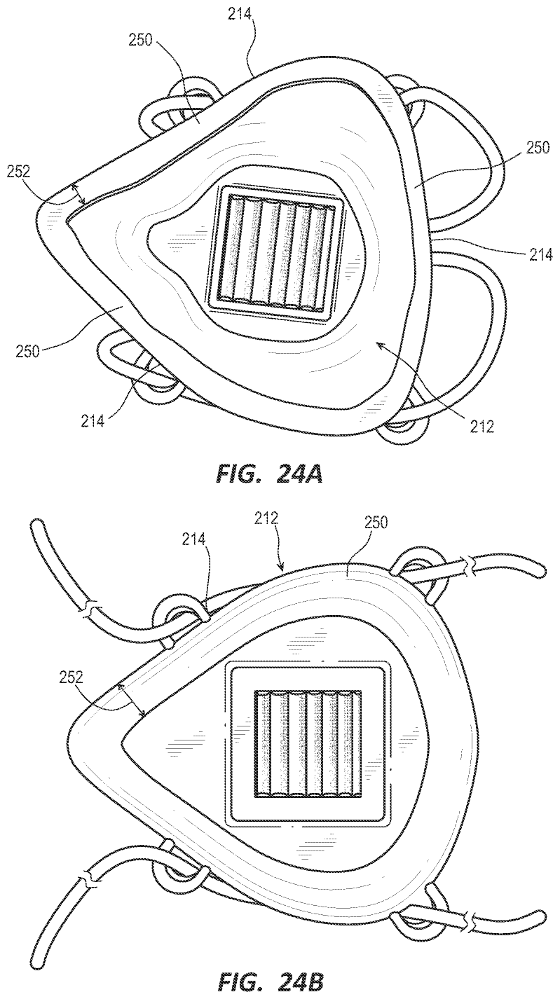

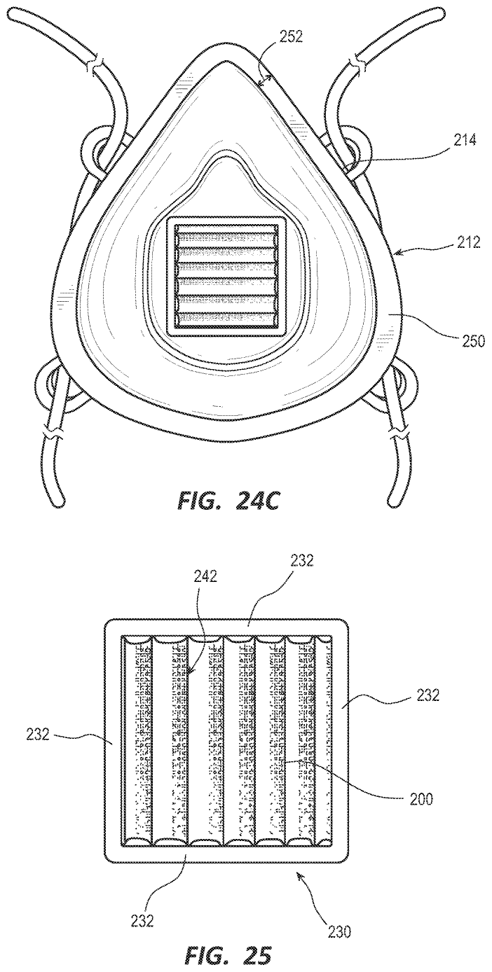

FIGS. 24A, 24B, and 24C show back perspective views of an alternative embodiment of a filtering mask body 212 that includes an inverted flange 250 extending from an edge 214 of the mask body 212. In use, the edge 214 and the inverted flange 250 fit against the user's face, and the mask body 212 forms an interior cavity around the user's nose and mouth. The edge 214 and the inverted flange 250 form a seal against the user's face, preventing contaminants, such as dust, fumes, germs, viruses, bacteria, and other particulate from entering or leaving the interior cavity.

In the illustrated embodiments, the mask body 212 and the inverted flange 250 are formed of the same materials. In alternative embodiments, the mask body 212 and the inverted flange 250 are formed of different materials. For example, the mask body 212 may be formed from a plastic material or a pliable soft material to form a comfortable mask for the user. The inverted flange 250 may be formed of a softer plastic material or a pliable softer material to increase the comfort of the user while forming a seal against the user's face. Specifically, the composition of the inverted flange 250 enables the formation of an inverted seal on the user's face.

Additionally, the length of the inverted flange 250 enables the edge 214 and the inverted flange 250 to be easily cleaned and to form a seal on the user's. Specifically, the inverted flange 250 has a length 252 of about 0.5 inches and extends into the interior cavity around the user's nose and mouth about 0.5 inches. The relatively short length of the inverted flange 250 enables a user to easily clean and disinfect the inverted flange 250 and the mask body 212 after use.

FIG. 25 shows a top view of an alternative embodiment of a filter frame 230 that includes a pleated filter 200 positioned within the filter frame 230. The filter frame 230 is substantially similar to the frame 30 except the filter frame 230 does not include internal supports 40 and includes the pleated filter 200. Specifically, the filter frame 230 includes sides 232 that form a single air passage 242. Removing the internal supports 40 and including the pleated filter 200 improves the comfort of the user because the air flow is improved while the filtering ability of the filter frame 230 remains the same.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

The description set forth herein, in connection with the appended drawings, describes example configurations and does not represent all the examples that may be implemented or that are within the scope of the claims. The term “exemplary” as may be used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (e.g., A and B and C).

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A filtering mask device, comprising:
a mask body configured to cover a user's nose and mouth to define an interior cavity, the mask body comprising:
an interior edge adapted to fit to a contour of the user's face;
an opening having an interior surface;
a filter frame adapted to fit substantially within the opening of the mask body and having an interior side, an exterior side, and an outer edge, the filter frame defining one or more air passages that permit airflow between the interior side and the exterior side; and
a filter material that covers the one or more air passages and filters air passing therethrough.

2. The filtering mask device of claim 1, wherein the filter material is removably attached to the filter frame.

3. The filtering mask device of claim 1, wherein the filter material is situated between the outer edge of the filter frame and the interior surface of the mask body.

4. The filtering mask device of claim 1, wherein the filter material is held in place by pressure between the outer edge of the filter frame and the interior edge of the mask body.

5. The filtering mask device of claim 1, wherein the filter frame further comprises one or more tension knobs, and the filter material is held in place between the one of more tension knobs of the filter frame and the interior surface of the mask body.

6. The filtering mask device of claim 1, wherein the filter frame includes a taper angle to allow for an airtight press-fit between the mask body, the filter material, and the filter frame.

7. The filtering mask device of claim 1, wherein the filter frame includes a flange running generally along at least a portion of the outer edge, the flange to control movement of the filter frame within the opening.

8. The filtering mask device of claim 1, wherein the filter frame includes a flange running generally along at least a portion of the outer edge proximate the outer side, the flange to prevent the filter frame from falling into the interior cavity.

9. The filtering mask device of claim 1, wherein the mask body further comprises a flange situated along at least a portion of the interior side of the opening, the flange to prevent the filter frame from falling into the interior cavity.

10. The filtering mask device of claim 1, further comprising a gasket running along the interior edge and adapted to form a substantially airtight seal between the mask body and the user's face.

11. The filtering mask device of claim 1, wherein the mask body is generally rigid.

12. The filtering mask device of claim 1, wherein the mask body is formed from a plastic material.

13. A method of assembling a filtering mask device, comprising:
providing a mask body, a filter frame, and a filter material, the mask body configured to cover a user's nose and mouth to define an interior cavity of air therearound, the mask body comprising an interior edge adapted to fit to a contour of the user's face, and an opening having an interior surface, a filter frame having an interior side, an exterior side, and an outer edge, the filter frame defining one or more air passages that permit airflow between the interior side and the exterior side;
positioning the filter frame substantially within the opening of the mask body;
arranging the filter material covering the one or more air passages to filter air passing therethrough.

14. The method of claim 13, further comprising releasably connecting the filter material to the filter frame.

15. The method of claim 13, further comprising releasably connecting the filter frame to the mask body.

16. The method of claim 13, wherein the filter material is fixed to the filter frame, and the filter frame is removably mounted to the mask body.

17. The method of claim 13, wherein the filter material is fixed to the filter frame, and the filter frame is replaceable with a separate filter frame with separate filter material.

18. The method of claim 13, further comprising providing a snap-fit connection between the filter frame and the mask body.

19. The method of claim 13, further comprising providing adapters in the mask body opening to allow for use of existing devices or alternate filter arrangements with the mask body.
